(19) United States
(12) Patent Application Publication
(10) Pub. No.: US 2007/0007700 A1
(43) Pub. Date: Jan. 11, 2007

(54) Method for Preparing Dielelectric Paste for Multi-Layer Ceramic Electronic Component

(75) Inventors: Shigeki Satou, Tokyo (JP); Akira Yamaguchi, Tokyo (JP)

Correspondence Address: SEED INTELLECTUAL PROPERTY LAW GROUP PLLC, 701 FIFTH AVE, SUITE 5400, SEATTLE, WA, 98104, US

(73) Assignee: TDK Corporation, Tokyo (JP)

(21) Appl. No.: 10/573,958

(22) PCT Filed: Sep. 28, 2004
(86) PCT No.: PCT/JP04/14160

§ 371 Date: Mar. 29, 2006

(30) Foreign Application Priority Data
Sep. 30, 2003 (JP) 2003-340399

(51) Int. Cl. B28C 1/04; C04B 33/32

(52) U.S. Cl. 264/650; 156/89.12; 156/246

(57) ABSTRACT

It is an object of the present invention to provide a method for preparing a dielectric paste for a multi-layered ceramic electronic component that enables preparation of a dielectric paste in which a dielectric material is dispersed with a high dispersibility while controlling the concentration of the dielectric material in a desired manner. The method for preparing a dielectric paste for a multi-layered ceramic electronic component includes a kneading step of kneading a dielectric powder, a binder and a solvent to form a clay-like mixture and a slurrying step of adding the same solvent as that used at the kneading step to the mixture obtained by the kneading step to lower the viscosity of the mixture, thereby slurrying the mixture.

### BACKGROUND OF THE INVENTION

1. Field of the Invention

The present invention relates to a method for preparing a dielectric paste for a multi-layered ceramic electronic component, and particularly to a method for preparing a dielectric paste for a multi-layered ceramic electronic component that enables preparation of a dielectric paste in which a dielectric material is dispersed with a high dispersibility while controlling the concentration of the dielectric material in a desired manner.

2. Description of the Related Art

Recently, the need to downsize various electronic devices makes it necessary to downsize the electronic components incorporated in the devices and improve the performance thereof. Also in multi-layered ceramic electronic components, such as multi-layered ceramic capacitors, it is strongly required to increase the number of layers and make the laminated unit thinner.

When a multi-layered ceramic electronic component as typified by a multi-layered ceramic capacitor is to be manufactured, ceramic powders, a binder such as an acrylic resin, a butyral resin or the like, a plasticizing agent such as a phthalate ester, glycol, adipate ester, phosphate ester or the like, and an organic solvent such as toluene, methyl ethyl ketone, acetone or the like are mixed and dispersed, thereby preparing a dielectric paste.

The dielectric paste is then applied onto a support sheet made of polyethylene terephthalate (PET), polypropylene (PP) or the like using an extrusion coater, a gravure coater or the like to form a coating layer and the coating layer is heated to dryness, thereby fabricating a ceramic green sheet.

Further, an electrode paste such as of nickel is printed onto the ceramic green sheet in a predetermined pattern using a screen printer and is dried to form an electrode layer.

When the electrode layer has been formed, the ceramic green sheet on which the electrode layer is formed is peeled off from the support sheet to form a multi-layered unit including the ceramic green sheet and the electrode layer. Then, a ceramic green chip is formed by laminating a desired number of the multi-layered units to form the laminated body, pressing the laminated body and dicing the laminated body.

Finally, the binder is removed from the green chip, the green chip is baked and an external electrode is formed, thereby completing a multi-layered ceramic electronic component such as a multi-layered ceramic capacitor.

At present, the need to downsize electronic components and improve the performance thereof makes it necessary to set the thickness of the ceramic green sheet determining the spacing between layers of a multi-layered ceramic capacitor to be equal to or smaller than 3 μm or 2 μm and to laminate three hundred or more multi-layered units each including a ceramic green sheet and an electrode layer.

However, in a conventional multi-layered ceramic capacitor, since an electrode layer is formed on the ceramic green sheet in a predetermined pattern, a step is formed between the surface of the electrode layer and the surface of the ceramic green sheet where no electrode layer is formed. Therefore, in the case of laminating a number of multi-layered units each including a ceramic green sheet and an electrode layer, it is difficult to bond the ceramic green sheets included in the number of multi-layered units in a desired manner so that the laminated body fabricated by laminating the number of multi-layered units is often deformed and delamination of layers sometimes occurs.

In order to solve these problems, it has been proposed to eliminate steps on the surface of the ceramic green sheet by printing a dielectric paste on the surface of the ceramic green sheet in a complementary pattern to that of the electrode layer, thereby forming a spacer layer between neighboring electrode layers.

In the case where the spacer layer is printed on the ceramic green sheet between neighboring electrode layers in this manner, thereby fabricating the multi-layered unit, steps on the surface of the ceramic green sheet of each multi-layered unit can be eliminated and even in the case of laminating a number of multi-layered units each including a ceramic green sheet and an electrode layers and fabricating a multi-layered ceramic capacitor, it is possible to bond the ceramic green sheets included in the number of multi-layered units in a desired manner and it is possible to prevent the laminated body fabricated by laminating a number of multi-layered units each including the ceramic green sheet and the electrode layer from being deformed.

The need to minimize the thickness of the multi-layered ceramic capacitor makes it necessary to form electrode layers having a thickness equal to or thinner than 2 μm, for example, and to satisfy this requirement it is necessary to improve the dispersibility of a conductive material contained in a conductive paste.

Specifically, in the case where the dispersibility of a conductive material contained in a conductive paste is low, the density of the conductive material in an electrode layer obtained by printing the conductive paste on a ceramic green sheet and drying the conductive paste becomes low and the electrode layer markedly contracts when the multi-layered ceramic capacitor is baked. Therefore, in the case where thin electrode layers are formed by printing, the electrode layers become discontinuous after baking and the overlapping area of the capacitor electrodes becomes small, whereby the effective capacitance of the capacitor becomes low.

On the other hand, a spacer layer is formed of a dielectric paste having the same composition as that of the dielectric paste for forming the ceramic green sheet and contains a dielectric powder, a binder, a plasticizing agent and an organic solvent. In the case where the need to minimize the thickness of the multi-layered ceramic capacitor makes it necessary to form an electrode layer having a thickness equal to or thinner than 2 μm, for example, it is necessary to form a spacer layer having substantially the same thickness as that of the electrode layer with a high accuracy by printing a dielectric paste on the ceramic green sheet so that the thickness of the spacer layer is substantially the same as that of the electrode layer after baking.

As in the case of the conductive paste for forming an electrode layer, it is necessary for satisfying such requirement to control the concentration of the dielectric material contained in the dielectric paste for forming the spacer layer with high accuracy and improve the dispersibility of the dielectric material contained in the dielectric paste, thereby increasing the density of the dielectric material contained in the spacer layer obtained by printing the dielectric paste on a ceramic green sheet and drying the dielectric paste.

Thus, Japanese Patent Application Laid Open No. 2001-237140 proposes a method for preparing a dielectric paste containing a highly dispersed dielectric powder comprising steps of mixing a dielectric powder and a low boiling point solvent such as methyl ethyl ketone, acetone or the like using a ball mill, thereby dispersing the dielectric powder in the solvent, adding a high boiling point solvent such as terpineol and an organic binder such as ethylcellulose to the thus obtained dispersed product, mixing them, thereby preparing a ceramic slurry, or mixing a dielectric powder, a low boiling point solvent such as methyl ethyl ketone, acetone or the like and a high boiling point solvent such as terpineol using a ball mill, thereby dispersing the dielectric powder in the solvents, adding a high boiling point solvent such as terpineol and an organic binder such as ethylcellulose to the thus obtained dispersed product, mixing them, thereby preparing a ceramic slurry, evaporating the low boiling point solvent using an evaporator or the like to remove the low boiling point solvent from the ceramic slurry, thereby preparing a dielectric paste, adding a high boiling point solvent such as terpineol to the thus obtained dielectric paste in order to adjust the viscosity of the dielectric paste and dispersing the dielectric powder in the solvents using an automatic mortar.

However, in the case where a dielectric paste is prepared in accordance with the method disclosed in Japanese Patent Application Laid Open No. 2001-237140, it is difficult to accurately control the amounts of the low boiling point solvent that have and have not been evaporated when evaporating the low boiling point solvent and it is extremely difficult to prepare a dielectric paste containing a desired concentration of a dielectric material. Therefore, it is extremely difficult to form a spacer layer having a desired dry thickness by printing the dielectric paste on the ceramic green sheet. On the other hand, in the case where a dielectric paste is prepared by evaporating a low boiling point solvent and the viscosity of the dielectric paste is adjusted by adding a high boiling point solvent such as terpineol to the dielectric paste, so-called solvent shock occurs. Specifically, the dielectric powder agglutinates owing to the mixing of solvents having different affinities for the dielectric powder and the sudden change in the solids concentration. As a result, it is sometimes impossible to obtain a dielectric paste in which the dielectric material is dispersed with a high dispersibility.

### BRIEF SUMMARY OF THE INVENTION

It is therefore an object of the present invention to provide a method for preparing a dielectric paste for a multi-layered ceramic electronic component that enables preparation of a dielectric paste in which a dielectric material is dispersed with a high dispersibility while controlling the concentration of the dielectric material in a desired manner.

The above object of the present invention is accomplished by a method for preparing a dielectric paste for a multi-layered ceramic electronic component comprising a kneading step of kneading a dielectric powder, a binder and a solvent to form a clay-like mixture and a slurrying step of adding the same solvent as that used at the kneading step to the mixture obtained by the kneading step to lower the viscosity of the mixture, thereby slurrying the mixture.

According to the present invention, since the concentration of the dielectric material contained in the dielectric paste depends upon the amount of the solvent added to the mixture, it is possible to prepare a dielectric paste containing a desired concentration of a dielectric material.

Further, according to the present invention, since the same solvent as that used at the kneading step is added to the mixture in order to adjust the viscosity of the dielectric paste, it is possible to reliably prevent so-called solvent shock from occurring and therefore, a dielectric paste containing a highly dispersed dielectric material can be prepared.

In a preferred aspect of the present invention, the dielectric powder, the binder and the solvent are kneaded until the mixture reaches the wetting point (ball point) thereof.

In a preferred aspect of the present invention, the dielectric powder, the binder and the solvent are kneaded until the solids concentration of the mixture reaches 85 to 95%.

In a preferred aspect of the present invention, the dielectric powder, the binder and the solvent are kneaded using a mixer selected from a group consisting of a high speed shearing mixer, a planetary type kneading machine and a kneader.

In a preferred aspect of the present invention, the method for preparing a dielectric paste for a multi-layered ceramic electronic component further comprises a step of continuously dispersing the slurry obtained by the slurrying step using a closed type emulsifier, thereby preparing a dielectric paste.

According to this preferred aspect of the present invention, since the slurry is continuously dispersed using a closed type emulsifier, thereby preparing a dielectric paste, it is possible to further improve the dispersibility of the dielectric material contained in the dielectric paste and control the concentration of the dielectric material contained in the dielectric paste in a desired manner.

Further according to this preferred aspect of the present invention, since the slurry is continuously dispersed using a closed type emulsifier, thereby preparing a dielectric paste, it is possible to suppress change in the solids concentration of the slurry at the dispersing step and markedly improve the efficiency of manufacture of the dielectric paste in comparison with the case where the slurry is dispersed using a three-roll mill to prepare a dielectric paste.

According to the present invention, it is possible to provide a method for preparing a dielectric paste for a multi-layered ceramic electronic component that enables preparation of a dielectric paste in which a dielectric material is dispersed with a high dispersibility while controlling the concentration of the dielectric material in a desired manner.

### DETAILED DESCRIPTION OF THE INVENTION

In the present invention, it is preferable for the dielectric powder, the binder and the solvent to be kneaded until the mixture reaches the wetting point thereof and it is more preferable for the dielectric powder, the binder and the solvent to be kneaded until the solids concentration of the mixture reaches 85 to 95%.

In the present invention, it is preferable for the dielectric powder, the binder and the solvent to be kneaded using a mixer selected from a group consisting of a high speed shearing mixer, a planetary type kneading machine and a kneader.

In the present invention, as the high speed shearing mixer, a “Henshel Mixer” (Product Name) manufactured by Mitsui Mining Co., Ltd., a “Eirich Mixer” (Product Name) manufactured by Nippon Eirich Co., Ltd. and the like are preferably employed and when the dielectric powder, the binder and the solvent are kneaded using the high speed shearing mixer, the number of revolutions of the high speed shearing mixer is normally set to 500 r. p. m. to 3000 r. p. m.

In the present invention, as the planetary type kneading machine, a planetary mixer which is a planetary type mixing machine/kneading machine having two or more shafts is preferably employed and when the dielectric powder, the binder and the solvent are kneaded using the planetary mixer, the planetary mixer is operated at a low speed equal to or lower than 100 r. p. m., thereby kneading the dielectric powder, the binder and the solvent.

In the present invention, when the dielectric powder, the binder and the solvent are kneaded using the kneader, the kneader is operated at a low speed equal to or lower than 100 r. p. m., thereby kneading the dielectric powder, the binder and the solvent.

In the present invention, it is preferable to add 0.25 to 3.0 weight parts of the binder and 4.75 to 19.0 weight parts of the solvent to 100 weight parts of the dielectric powder and knead the dielectric powder, the binder and the solvent until the solids concentration of the mixture reaches 85 to 95% and it is more preferable to add 0.5 to 2.0 weight parts of the binder and 5.0 to 15.0 weight parts of the solvent to 100 weight parts of the dielectric powder and knead the dielectric powder, the binder and the solvent until the solids concentration of the mixture reaches 85 to 95%.

In the present invention, it is preferable to dissolve the binder into the solvent, thereby preparing an organic vehicle, add 3 to 15 weight % of the organic vehicle to the dielectric powder and knead the dielectric powder, the binder and the solvent.

In the present invention, it is preferable to add a dispersing agent to the mixture obtained by the kneading step, thereby slurrying the mixture.

In the present invention, it is more preferable to add 0.25 to 2.0 weight parts of the dispersing agent with respect to 100 weight parts of the dielectric powder to the mixture obtained by the kneading step, thereby lowering the viscosity of the mixture, and then add the solvent to the mixture, thereby slurrying the mixture.

In the present invention, it is preferable to add a dispersing agent to the mixture obtained by the kneading step and slurry the mixture until the solids concentration of the mixture becomes 40 to 50% and the viscosity of the mixture becomes several pascal to several dozen pascal.

In the present invention, it is preferable to further continuously disperse the slurry obtained by the slurrying step using an enclosed type emulsifier, thereby preparing the dielectric paste.

In the present invention, it is more preferable to further continuously disperse the slurry obtained by the slurrying step using a homogenizer or a colloid mill, thereby preparing the dielectric paste.

The binder used in the present invention is not particularly limited but it is preferable to use a binder selected from a group consisting of ethylcellulose, polyvinyl butyral, acrylic resin and the mixture thereof as the binder in the present invention.

The solvent used in the present invention is not particularly limited but it is preferable to use a solvent selected from a group consisting of terpineol, dihydroterpineol, butyl carbitol, butyl carbitol acetate, terpineol acetate, dihydroterpineol acetate, kerosene and mixtures thereof as the solvent in the present invention.

The dispersing agent used in the present invention is not particularly limited and a polymer type dispersing agent, a nonionic dispersing agent, an anionic dispersing agent, a cationic dispersing agent or an ampholytic surfactant can be used in the present invention. Among these, a nonionic dispersing agent is preferable and a polyethyleneglycol system dispersing agent whose hydrophile-liophile balance (HLB) is 5 to 7 is particularly preferable in the present invention.

The dielectric paste prepared in accordance with the present invention is printed using a screen printing machine or the like on the surface of a ceramic green sheet in a complimentary pattern to that of an electrode layer printed on the surface of the ceramic green sheet, thereby forming a spacer layer and a multi-layered unit including the ceramic green sheet, the electrode layer and the spacer layer is fabricated by peeling off a support sheet from the ceramic green sheet.

It is possible to print the dielectric paste prepared in accordance with the present invention on the surface of a ceramic green sheet using a screen printing machine or the like in a complimentary pattern to that of an electrode layer, thereby forming a spacer layer, and print a conductive paste on the surface of a ceramic green sheet using a screen printing machine or the like after drying the spacer layer, thereby forming the electrode layer.

Further, it is possible to form a ceramic green sheet on the surface of a first support sheet, print a conductive paste on the surface of a second support sheet, thereby forming an electrode layer, print the dielectric paste prepared in accordance with the present invention on the surface of the second support sheet in a complimentary pattern to that of the electrode layer, thereby forming a spacer layer, transfer an adhesive layer formed on the surface of a third support sheet onto the surface of the ceramic green sheet or the surfaces of the electrode layer and the spacer layer and bond the ceramic green sheet and the electrode layer and the spacer layer via the adhesive layer, thereby fabricating a multi-layered unit.

A desired number of the thus fabricated multi-layered units are laminated and pressed to fabricate a laminated body and the thus obtained laminated body is diced, whereby a ceramic green chip is fabricated.

Further, the binder is removed from the green chip, the green chip is baked and an external electrode is formed, thereby completing a multi-layered ceramic electronic component such as a multi-layered ceramic capacitor.

### WORKING EXAMPLES

Hereinafter, a working example and a comparative example will be set out in order to further clarify the advantages of the present invention.

### WORKING EXAMPLE

A dielectric paste was prepared in the following manner so that the concentration of a dielectric material contained in the dielectric paste was 43 weight %.

1.48 weight parts of (BaCa)SiO₃, 1.01 weight parts of Y₂O₃, 0.72 weight part of MgCO₃, 0.13 weight part of MnO and 0.045 weight part of V₂O₅ were mixed, thereby preparing an additive powder.

150 weight parts of acetone, 104.3 weight parts of terpineol and 1.5 weight parts of polyethylenglycol system dispersing agent were added to 100 weight parts of the thus prepared additive powder to prepare a slurry and the additives contained in the slurry were pulverized using a pulverizer “LMZ0.6” (Product name) manufactured by Ashizawa Finetech Co., Ltd.

When the additives contained in the slurry were to be pulverized, ZrO₂ beads having a diameter of 0.1 mm were charged into a vessel so as to occupy 80 volume % of the vessel, a rotor was rotated at the circumferential velocity of 14 m/min and the slurry was circulated between the vessel and a slurry tank until holding time of the whole slurry became 5 minutes, thereby pulverizing the additives contained in the slurry.

The median diameter of the additives after pulverization was 0.1 μm.

Then, acetone was evaporated using an evaporator and removed from the slurry, thereby preparing an additive paste in which the additives were dispersed in terpineol. The concentration of the additives contained in the additive paste was 49.3 weight %.

Further, a BaTiO₃ powder “BT-02” (Product Name) manufactured by SAKAI CHEMICAL INDUSTRY CO., LTD and having a particle diameter of 0.2 μm was employed as a dielectric powder, 9.3 weight parts of the additive paste was added to 100 weight parts of the dielectric powder and a mixture was mixed using a planetary mixer. The number of revolutions of the planetary mixer was set to 50 r. p. m.

Then, 5 weight parts of polyvinyl butyral (degree of polymerization: 2400, butyral degree: 69%, degree of acetalization: 12%) was dissolved in 95 weight parts of terpineol at 70° C., thereby preparing a 5% solution of an organic vehicle. The thus prepared organic vehicle solution was gradually added to and mixed into a mixture of the dielectric powder, the additive paste and the polyethylenglycol system dispersing agent until the mixture of the dielectric powder, the additive paste and the polyethylenglycol system dispersing agent became clay-like and the load current value of a kneader which once became extremely high decreased and became stable at a constant value.

When the mixture was kneaded for thirty hours and 12.1 weight parts of the organic vehicle solution was then added to the mixture, the load current value became stable at a constant value.

Then, 1 weight part of a polyethylenglycol system dispersing agent was added to the clay-like mixture to lower the viscosity of the clay-like mixture, thereby obtaining a cream-like mixture.

Further, 0.5 weight parts of imidazoline system surfactant as an antistatic auxiliary agent, 2.3 weight parts of dioctyl phthalate as a plasticizing agent, 81.3 weight parts of the remaining organic vehicle solution and 34.7 weight parts of terpineol were added to the clay-like mixture, thereby gradually lowering the viscosity of the clay-like mixture.

Then, the thus obtained clay-like mixture was subjected to a dispersing treatment using a colloid mill three times under conditions of a colloid mill gap of 40 μm and revolution speed of 1800 r. p. m., thereby preparing a dielectric paste.

The viscosity of the thus obtained dielectric paste was measured using a rheometer manufactured by HAKKE Co., Ltd. under conditions of a temperature of 25° C. and shearing velocity of 8 sec¹.

Further, 1 gram of the thus obtained dielectric paste was weighed out into a crucible and decrepitated at 600° C. and the weight of the dielectric paste after the decrepitation was measured, thereby measuring the concentration of the dielectric material contained in the dielectric paste.

The results of the measurement of the viscosity of the dielectric paste and the concentration of the dielectric material are shown in Table 1.

Further, whether or not any coarse particles and undissolved resin component were contained in the dielectric paste was measured using a grind gauge.

The result of the measurement is shown in Table 1.

Next, the dielectric paste was printed onto a polyethylene terephthalate film using a screen printing process and dried at 80° C. for five minutes, thereby forming a dielectric film. Then, the surface roughness (Ra), the glossiness and the density of the thus obtained dielectric film were measured.

Here, the surface roughness (Ra) of the dielectric film was measured using the “SURFCORDER (SE-30D)” (Product Name) manufactured by Kosaka Laboratory Ltd. and the glossiness of the dielectric film was measured using a glossmeter manufactured by Nippon Denshoku Kogyo Co., Ltd.

On the other hand, a 12 mm round sample was punched out of the dried dielectric film and the density of the dielectric film was calculated from the weight of the sample measured with a precision balance and the thickness thereof measured with a micrometer.

The result of the measurement is shown in Table 1.

### COMPARATIVE EXAMPLE

A dielectric paste was prepared in the following manner so that the concentration of the dielectric material contained in the dielectric paste was 43 weight %.

An additive paste was first prepared in the manner of Working Example.

Then, a slurry having the following composition was dispersed for sixteen hours using a ball mill.

The conditions of the dispersing operation were set so that the amount of charged ZrO₂ having a diameter of 2.0 mm was 30 volume % of the ball mill, the amount of the slurry in the ball mill was 60 volume % and the circumferential velocity of the ball mill was 45 m/min.

| | | |
|---|---|---|
| dielectric powder | 100 | weight parts |
| additive paste | 9.3 | weight parts |
| polyvinyl butyral | 4.5 | weight parts |
| polyethylene glycol system dispersing agent | 1.0 | weight part |
| dioctyl phthalate | 2.25 | weight parts |
| terpineol | 120 | weight parts |
| acetone | 57 | weight parts |

Here, a BaTiO₃ powder (“BT-02” (Product Name) manufactured by SAKAI CHEMICAL INDUSTRY CO., LTD was used as a dielectric powder and the degree of polymerization, the butyral degree and the degree of acetalization of the polyvinyl butyral were 2400, 69% and 12%, respectively.

After the dispersing operation, acetone was evaporated using a stirring device having an evaporator and a heating mechanism and removed from the slurry, thereby preparing a dielectric paste.

The viscosity of the thus obtained dielectric paste was measured using a rheometer manufactured by HAKKE Co., Ltd. under the conditions of a temperature of 25° C. and a shearing velocity of 8 sec⁻¹.

Further, 1 gram of the thus obtained dielectric paste was accommodated in a crucible and decrepitated at 600° C. and the weight of the dielectric paste after the decrepitation was measured, thereby measuring the concentration of the dielectric material contained in the dielectric paste.

The results of the measurement of the viscosity of the dielectric paste and the concentration of the dielectric material are shown in Table 1.

Further, whether or not any coarse particles and undissolved resin component were contained in the dielectric paste was measured using a grind gauge.

The result of the measurement is shown in Table 1.

Next, the dielectric paste was printed onto a polyethylene terephthalate film using a screen printing process and dried at 80° C. for five minutes, thereby forming a dielectric film. Then, the surface roughness (Ra), the glossiness and the density of the thus obtained dielectric film were measured in the manner of Working Example.

The results of the measurements are shown in Table 1.

TABLE 1

| | | Concentration of | | | Glossiness of | Density of |
|---|---|---|---|---|---|---|
| | Viscosity of | Dielectric | Coarse | Surface | Dielectric film | Dielectric film |
| | Paste(Pa) | material(weight %) | Particles(μm) | Roughness(μm) | (%) | (%) |
| Working Example | 5.6 | 43.1 | none | 0.06 | 58 | 3.7 |
| Comparative Example | 8.4 | 45.1 | 20 | 0.09 | 30 | 3.3 |

As shown in Table 1, it was found that the viscosity of the dielectric paste prepared in accordance with Working Example was 5.6 Pa, while the viscosity of the dielectric paste prepared in accordance with Comparative Example was 8.4 Pa, and that the dielectric material was highly dispersed in the dielectric paste prepared in accordance with Working Example.

Further, as shown in Table 1, it was found that although the concentration of the dielectric material contained in the dielectric paste prepared in accordance with Comparative Example was 45.1% and considerably different from 43% which was the target concentration of the dielectric material contained in the dielectric paste, the concentration of the dielectric material contained in the dielectric paste prepared in accordance with Working Example was 43.1% and substantially coincided with 43% which was the target concentration of the dielectric material contained in the dielectric paste.

Thus, it was found that according to the present invention, the concentration of a dielectric material contained in a dielectric paste could be controlled in a desired manner.

Further, while no coarse particles and undissolved resin component were detected in the dielectric paste prepared in accordance with Working Example, coarse particles measuring 20 μm in diameter were detected in the dielectric paste prepared in accordance with Comparative Example. It is reasonable to conclude that this was because the dispersibility of the dielectric material was improved in the dielectric paste prepared in accordance with Working Example.

Furthermore, as shown in Table 1, it was found that the dielectric film fabricated in accordance with Comparative Example had a higher surface roughness Ra and was poorer in surface smoothness than the dielectric film fabricated in accordance with Working Example. It is reasonable to assume that this was because the dielectric paste prepared in accordance with Comparative Example contained coarse particles measuring 20 μm in diameter and was poorer in the dispersibility of the dielectric material than the dielectric paste prepared in accordance with Working Example.

Moreover, as shown in Table 1, it was found that both the gloss level and the density of the dielectric film fabricated in accordance with Working Example were higher than those of the dielectric film fabricated in accordance with Comparative Example. It is reasonable to assume that this was because the dispersibility of the dielectric material in the dielectric paste prepared in accordance with Working Example was higher than that in the dielectric paste prepared in accordance with Comparative Example.

As described above, it was found from Working Example and Comparative Example that the dielectric material was highly dispersed in the dielectric paste prepared in accordance with the present invention and that according to the present invention, it was possible to prepare a dielectric paste in which a dielectric material was dispersed with a high dispersibility.

Further, it was found from Working Example and Comparative Example that the concentration of the dielectric material contained in the dielectric paste prepared in accordance with the present invention substantially coincided with the target concentration of the dielectric material and that according to the present invention, it was possible to control the concentration of a dielectric material contained in a dielectric paste in a desired maner.

The present invention has thus been shown and described with reference to a working example. However, it should be noted that the present invention is in no way limited to the details of the described arrangement but changes and modifications may be made without departing from the scope of the appended claims.

For example, in Working Example, although the clay-like mixture was dispersed using a colloid mill, it is not absolutely necessary to disperse the clay-like mixture using a colloid mill and the clay-like mixture may be dispersed using a homogenizer instead of a colloid mill.

Further, in Working Example, although the dielectric powder, the additive paste and the dispersing agent were kneaded using a planetary mixer, it is not absolutely necessary to knead the dielectric powder, the additive paste and the dispersing agent using a planetary mixer and the dielectric powder, the additive paste and the dispersing agent may be kneaded using a kneader or a high speed shearing mixer such as a “Henshel Mixer” (Product Name) manufactured by Mitsui Mining Co., Ltd., an “Eirich Mixer” (Product Name) manufactured by Nippon Eirich Co., Ltd. or the like instead of a planetary mixer.

1. A method for preparing a dielectric paste for a multi-layered ceramic electronic component comprising a kneading step of kneading a dielectric powder, a binder and a solvent to form a clay-like mixture and a slurrying step of adding the same solvent as that used at the kneading step to the mixture obtained by the kneading step to lower the viscosity of the mixture, thereby slurrying the mixture.

2. The method for preparing a dielectric paste for a multi-layered ceramic electronic component in accordance with claim 1, wherein the dielectric powder, the binder and the solvent are kneaded until the mixture reaches the wetting point (ball point) thereof.

3. The method for preparing a dielectric paste for a multi-layered ceramic electronic component in accordance with claim 1, wherein the dielectric powder, the binder and the solvent are kneaded until the solids concentration of the mixture reaches 85 to 95%.

4. The method for preparing a dielectric paste for a multi-layered ceramic electronic component in accordance with claim 1, wherein the dielectric powder, the binder and the solvent are kneaded using a mixer selected from a group consisting of a high speed shearing mixer, a planetary type kneading machine and a kneader.

5. The method for preparing a dielectric paste for a multi-layered ceramic electronic component in accordance with claim 3, which comprises steps of adding 0.25 to 3.0 weight parts of the binder and 4.75 to 19.0 weight parts of the solvent to 100 weight parts of the dielectric powder and kneading the dielectric powder, the binder and the solvent until the solids concentration of the mixture reaches 85 to 95%.

6. The method for preparing a dielectric paste for a multi-layered ceramic electronic component in accordance with claim 5, which comprises steps of adding 0.5 to 2.0 weight parts of the binder and 5.0 to 15.0 weight parts of the solvent to 100 weight parts of the dielectric powder and kneading the dielectric powder, the binder and the solvent until the solids concentration of the mixture reaches 85 to 95%.

7. The method for preparing a dielectric paste for a multi-layered ceramic electronic component in accordance with claim 1, which comprises steps of dissolving the binder into the solvent, thereby preparing an organic vehicle, adding 3 to 15 weight % of the organic vehicle to the dielectric powder and kneading the dielectric powder, the binder and the solvent.

8. The method for preparing a dielectric paste for a multi-layered ceramic electronic component in accordance with claim 1, which comprises a step of adding a dispersing agent to the mixture obtained by the kneading step, thereby slurrying the mixture.

9. The method for preparing a dielectric paste for a multi-layered ceramic electronic component in accordance with claim 8, which comprises steps of adding 0.25 to 2.0 weight parts of the dispersing agent with respect to 100 weight parts of the dielectric powder to the mixture obtained by the kneading step, thereby lowering the viscosity of the mixture, and then adding the solvent to the mixture, thereby slurrying the mixture.

10. The method for preparing a dielectric paste for a multi-layered ceramic electronic component in accordance with claim 1, which further comprises a step of continuously dispersing the slurry obtained by the slurrying step using an enclosed type emulsifier.

11. The method for preparing a dielectric paste for a multi-layered ceramic electronic component in accordance with claim 10, wherein the slurry obtained by the slurrying step is continuously dispersed using a homogenizer.

12. The method for preparing a dielectric paste for a multi-layered ceramic electronic component in accordance with claim 10, wherein the slurry obtained by the slurrying step is continuously dispersed using a colloid mill.

13. The method for preparing a dielectric paste for a multi-layered ceramic electronic component in accordance with claim 1, wherein a binder selected from a group consisting of ethylcellulose, polyvinyl butyral, acrylic resin and mixtures thereof is employed as the binder.

14. The method for preparing a dielectric paste for a multi-layered ceramic electronic component in accordance with claim 1, wherein a solvent selected from a group consisting of terpineol, dihydroterpineol, butyl carbitol, butyl carbitol acetate, terpineol acetate, dihydroterpineol acetate, kerosene and mixtures thereof is employed as the solvent.

15. The method for preparing a dielectric paste for a multi-layered ceramic electronic component in accordance with claim 1, wherein a nonionic dispersing agent is employed as the dispersing agent.

16. The method for preparing a dielectric paste for a multi-layered ceramic electronic component in accordance with claim 15, wherein a polyethyleneglycol system dispersing agent whose hydrophile-liophile balance (HLB) is 5 to 7 is employed as the dispersing agent.
